(19) United States
(12) Patent Application Publication
(10) Pub. No.: US 2026/0303205 A1
(43) Pub. Date: Oct. 1, 2026

(54) SYSTEMS, APPARATUSES, METHODS, AND NON-TRANSITORY COMPUTER-READABLE STORAGE MEDIA FOR FIBER-LONGITUDINAL POWER PROFILE ESTIMATION (PPE) EMPLOYING OPTIMIZED NON-UNIFORM SPATIAL COMPUTATION-STEP DISTRIBUTION

(71) Applicant: HUAWEI TECHNOLOGIES CO., LTD., Shenzhen (CN)

(72) Inventors: Yinfeng Yu, Ottawa (CA); Christopher Frank Janz, Ottawa (CA); Zhiping Jiang, Ottawa (CA); Yanpeng Wang, Ottawa (CA); Hesam Aldin Rahimi Koopayi, Ottawa (CA); Ruilin Cai, Ottawa (CA)

(21) Appl. No.: 19/317,932

(22) Filed: Sep. 3, 2025

Related U.S. Application Data
(60) Provisional application No. 63/778,879, filed on Mar. 27, 2025.

(51) Int. Cl. H04B 10/073

(52) U.S. Cl. CPC H04B 10/073

(57) ABSTRACT

A method for managing a fiber optic network having one or more fiber optic links, the method has the steps of: detecting an anomaly in a segment of one or more segments of the one or more fiber optic links, calculating a risk factor of each of the one or more segments upon the detection of the anomaly, and maintaining a risk map of the fiber optic network based on the detection of the anomaly and the calculated risk factors, for managing the fiber optic network.

### CROSS-REFERENCE TO RELATED APPLICATIONS

This application claims the benefit of U.S. Provisional Patent Application Ser. No. 63/778,879, filed Mar. 27, 2025, the content of which is incorporated herein by reference in its entirety.

### FIELD OF THE DISCLOSURE

The present disclosure relates generally to systems, apparatuses, methods, and computer-readable storage media for fiber-longitudinal power profile estimation (PPE), and in particular to systems, apparatuses, methods, and computer-readable storage media for fiber-longitudinal PPE employing optimized non-uniform spatial computation-step distribution.

### BACKGROUND

Fiber optic systems have been widely used. In many fiber optic systems, digital signal processing (DSP) based DSP-based optical performance monitoring (OPM) techniques are often used on the receiver (Rx) side for charactering cumulative parameters, such as optical signal to noise ratio (OSNR) and accumulated chromatic dispersion (CD), of an entire link. However, these techniques often fail to monitor longitudinally distributed link features such as span-wise fiber loss and optical amplifier gain spectra.

Hardware-based OPM techniques such as optical time-domain reflectometry (OTDR) are capable of monitoring distributed chrematistics of fiber link. However, additional hardware cost limits their application.

### SUMMARY

According to one aspect of this disclosure, there is provided a system comprising: a controller for managing a fiber optic network having a plurality of fiber optic links, each fiber optic link being partitioned into one or more segments; and a plurality of estimators controllable by the controller, each estimator for functionally connecting to a respective receiver of a plurality of receivers in the fiber optic network, each receiver being coupled to a respective fiber optic link of the plurality of fiber optic links in the fiber optic network; wherein each estimator is for estimating a power profile of the corresponding fiber optic link by: detecting one or more anomaly in the one or more segments of the corresponding fiber optic link, and calculating a risk factor of each of the one or more segments of the corresponding fiber optic link upon the detection of the one or more anomaly; and wherein the controller is for maintaining a risk map of the fiber optic network based on the detection of the one or more anomaly and the calculated risk factors obtained from each estimator, for managing the fiber optic network.

In some embodiments, the risk map comprises a plurality of units each corresponding to a respective segment of the segments of the fiber optic network, each unit comprising: a segment identifier (ID) of the corresponding segment; an anomaly counter of the corresponding segment; the risk factor of the corresponding segment; and a length of the corresponding segment.

In some embodiments, each estimator is configured for splitting the corresponding segment to a plurality of new segments when the risk factor of the corresponding segment is greater than one.

According to one aspect of this disclosure, there is provided a method for managing a fiber optic network having a plurality of fiber optic links, the method comprising: detecting an anomaly in a segment of one or more segments of the fiber optic link; calculating an average anomaly rate of the fiber optic network as:

$$\overline{θ} = \frac{total \# of anomaly reported of entire network}{total \# of segments of entire network} ;$$

calculating an average anomaly rate of the segment as:

$${\overline{θ}}_{segment} = \overline{θ} ( \frac{{length}_{segment}}{{avg\_length}_{segment}} ) ,$$

where:

$${avg\_length}_{segment} = \frac{total fiber length of entire network}{total \# of segments of entire network} ;$$

calculating an expected probability (P) of x anomaly in the segment as:

$${P}_{segment} ( X = x ) = \frac{( {e}^{- {\overline{θ}}_{segment}} ) {( {\overline{θ}}_{segment} )}^{x}}{x !} ;$$

calculating an observed frequency (f) of anomaly in the segment as:

$${f}_{segment} ( x ) = \frac{\# of segment with [ x ( \frac{{length}_{segment}}{{avg}_{{length}_{segment}}} ) ] number of anomaly}{total \# of segments} ;$$

and
calculating the risk factor (R) of the segment as:

$${R}_{segment} = \frac{{f}_{segment} ( x )}{{P}_{segment} ( X = x )} .$$

According to one aspect of this disclosure, there is provided a method for managing a fiber optic network having one or more fiber optic links, the method comprising: detecting an anomaly in a segment of one or more segments of the one or more fiber optic links; calculating a risk factor of each of the one or more segments upon the detection of the anomaly; and maintaining a risk map of the fiber optic network based on the detection of the anomaly and the calculated risk factors, for managing the fiber optic network.

In some embodiments, the method further comprises: if the risk factor of one of the one or more segments is greater than a predefined threshold, splitting the segment into a plurality of new segments for being included into said one or more segments.

In some embodiments, said splitting the segment into the plurality of new segments comprises: splitting the segment into two new segments for being included into said one or more segments.

In some embodiments, the risk map comprises a plurality of units each corresponding to a respective segment of the one or more segments of the fiber optic network, each unit comprising: a segment identifier (ID) of the corresponding segment; an anomaly counter of the corresponding segment; the risk factor of the corresponding segment; and a length of the corresponding segment.

In some embodiments, said calculating the risk factor of each of the one or more segments upon the detection of the anomaly comprises:
calculating an average anomaly rate of the fiber optic network as:

$$\overline{θ} = \frac{total \# of anomaly reported of entire network}{total \# of segments of entire network} ;$$

calculating an average anomaly rate of each segment as:

$${\overline{θ}}_{segment} = \overline{θ} ( \frac{{length}_{segment}}{{avg\_length}_{segment}} ) ,$$

where:

$${avg\_length}_{segment} = \frac{total fiber length of entire network}{total \# of segments of entire network} ;$$

calculating an expected probability (P) of x anomaly in each segment as:

$${P}_{segment} ( X = x ) = \frac{( {e}^{- {\overline{θ}}_{segment}} ) {( {\overline{θ}}_{segment} )}^{x}}{x !} ;$$

calculating an observed frequency (f) of anomaly in each segment as:

$${f}_{segment} ( x ) = \frac{\# of segment with [ x ( \frac{{length}_{segment}}{{avg}_{{length}_{segment}}} ) ] number of anomaly}{total \# of segments} ;$$

and,
calculating the risk factor (R) of each segment as:

$${R}_{segment} = \frac{{f}_{segment} ( x )}{{P}_{segment} ( X = x )} .$$

In some embodiments, the method further comprises: presenting the risk map on a graphic user interface (GUI).

According to one aspect of this disclosure, there is provided a system comprising: one or more estimators controllable by the controller, each estimator for functionally connecting to a respective receiver of one or more receivers in the fiber optic network, each receiver being coupled to a respective fiber optic link of the one or more fiber optic links in the fiber optic network; and a controller collaborating with the one or more estimators for performing any of the above-described methods.

According to one aspect of this disclosure, there is provided one or more processors functionally coupled to one or more non-transitory computer-readable storage media; wherein the one or more non-transitory computer-readable storage media comprise computer-executable instructions; and the instructions, when executed, cause the one or more processors to perform any of the above-described methods.

According to one aspect of this disclosure, there is provided one or more non-transitory computer-readable storage media comprising computer-executable instructions, wherein the instructions, when executed, cause one or more processors to perform any of the above-described methods.

The system and method disclosed herein provide an efficient power profile estimation (PPE) using non-uniform spatial step distribution, for reduced CPU and/or RAM intensity, and/or reduced computing time. The system and method disclosed herein may solve some problems that may otherwise limit PPE, and facilitate the commercialization of PPE.

As those skilled in the art understand, the anomalies or errors in a fiber optic system may comprise persistent anomalies such as those caused by loose connectors (which generally require identifying the locations thereof and repair), and random anomalies such as those caused by lightning (which often do not need repair). The system and method disclosed herein may be suitable for locating persistent anomalies with improved accuracy and efficiency.

### BRIEF DESCRIPTION OF THE DRAWINGS

For a more complete understanding of the disclosure, reference is made to the following description and accompanying drawings, in which:

FIG. 1 is a schematic diagram of a fiber optic system, according to some embodiments of this disclosure;

FIG. 2 is a schematic diagram showing a simplified hardware structure of a computing device of the fiber optic system shown in FIG. 1;

FIG. 3 a schematic diagram showing a simplified software architecture of a computing device of the fiber optic system shown in FIG. 1;

FIG. 4 is a schematic diagram showing a power profile estimation (PPE) method used in some application for monitoring the optical performance of the fiber optic system shown in FIG. 1;

FIG. 5 is a schematic diagram showing a fiber optic system for fiber-longitudinal PPE using optimized non-uniform spatial computation-step distribution, according to some embodiments of this disclosure;

FIG. 6 is a schematic diagram showing partitioning of an optical channel of the fiber optic system shown in FIG. 1, according to some embodiments of this disclosure;

FIG. 7 is a schematic diagram showing partitioning an optical transmission sections (OTS) of an optical channel of the fiber optic system shown in FIG. 1 into K segments, according to some embodiments of this disclosure;

FIG. 8 is a schematic diagram showing a method performed by an optical domain controller of the fiber optic system shown in FIG. 1 and the PPE component of a wavelength division multiplexing (WDM) device thereof, according to some embodiments of this disclosure;

FIG. 9 shows an example of a spatial step configuration sent from the optical domain controller to the PPE component, according to the method shown in FIG. 8;

FIG. 10 is a flowchart showing a procedure for monitoring optical performance using PPE performed by the optical domain controller and a network element of the fiber optic system shown in FIG. 1, according to some embodiments of this disclosure;

FIG. 11 shows an example of the data structure of a unit in a risk map storing information of the segments of the fiber optic system shown in FIG. 1, according to some embodiments of this disclosure;

FIG. 12A shows an example of segment partitioning of an OTS of an optical channel of the fiber optic system shown in FIG. 1;

FIG. 12B shows the data structure of the updated spatial (K) distribution of the segments sent from the optical domain controller to the PPE component of the network element of the fiber optic system shown in FIG. 1, according to some embodiments of this disclosure;

FIG. 13 shows an example of the data structure of the anomaly report sent from the PPE component of the network element to the optical domain controller of the fiber optic system shown in FIG. 1, according to some embodiments of this disclosure;

FIG. 14 is a schematic diagram showing OTS of an optical channel of the fiber optic system shown in FIG. 1, wherein an anomaly in a segment is detected;

FIG. 15 is a plot showing the determination of a risk factor of the segment shown in FIG. 14 in which an anomaly is detected, according to some embodiments of this disclosure;

FIG. 16 is a schematic diagram showing the segment shown in FIG. 14 being split into a plurality of new segments, according to some embodiments of this disclosure; and

FIG. 17 shows an example of providing improved observability of the risk map at service level and identification and displaying of the hotspots at the service level, according to some embodiments of this disclosure.

FIG. 18 is a flowchart showing a procedure for monitoring optical performance using PPE, according to some embodiments of this disclosure.

FIG. 19 depicts the details of fine-grained PPE calculation.

### DETAILED DESCRIPTION

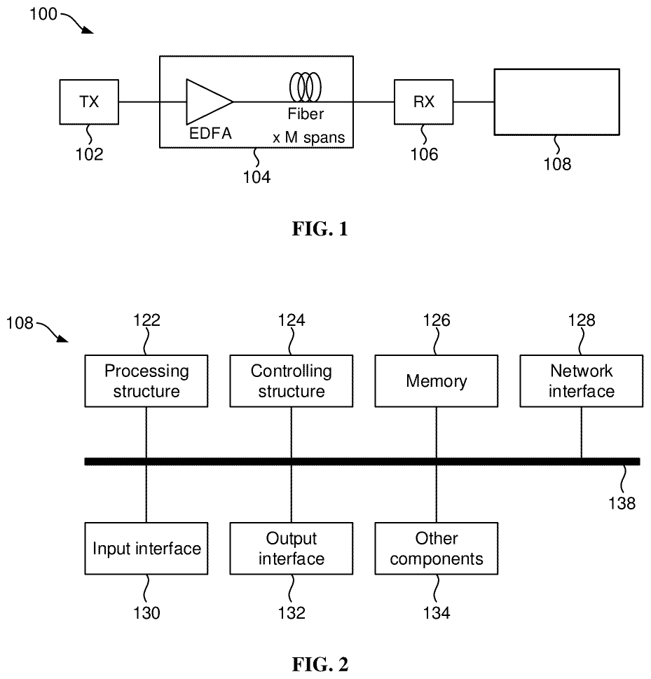

Turning now to FIG. 1, a simplified fiber optic system is shown and is generally identified using reference numeral 100. As shown, the fiber optic system 100 comprises a transmitter (Tx) 102 transmitting a signal through a fiber optic channel 104 (which may comprise various components such as amplifiers (for example, Erbium-doped fiber amplifiers (EDFAs), fiber optic links, and/or the like). A receiver (Rx) 106 receives the transmitted signal and may further process it for various purposes.

On the Rx side of the fiber optic system 100, a computing device 108 (which may be a computing component of the Rx 106, a computing component of a device functionally connected to the Rx 106, a standalone computing device functionally connected to the Rx 106, or the like) monitors the fiber optic channel 104.

FIG. 2 is a schematic diagram showing a simplified hardware structure of the computing device 108. As shown, the computing device 108 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more procedures, as the design purpose and/or the use case maybe. For example, the processing structure 122 may comprise logic gates implemented by semiconductors to perform various computations, calculations, and/or processing. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the procedures and functions thereof are “hard-coded” in the circuitry.

With the advance of technologies, it is often that a circuitry of logic gates such as the processing structure 122 may be alternatively designed in a general manner so that it may perform various procedures and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a procedure or a function (and thus the processor 122) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 108.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through a network by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touchpad, keyboards, computer mouse, trackball, microphone, scanners, cameras, and/or the like. The input interface 130 may be a physically integrated part of the computing device 108 (for example, the touchpad of a laptop computer or the touch-sensitive screen of a tablet), or may be a device physically separate from, but functionally coupled to, other components of the computing device 108 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 108 (for example, the display of a laptop computer or tablet), or may be a device physically separate from but functionally coupled to other components of the computing device 108 (for example, the monitor of a desktop computer).

The computing device 108 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

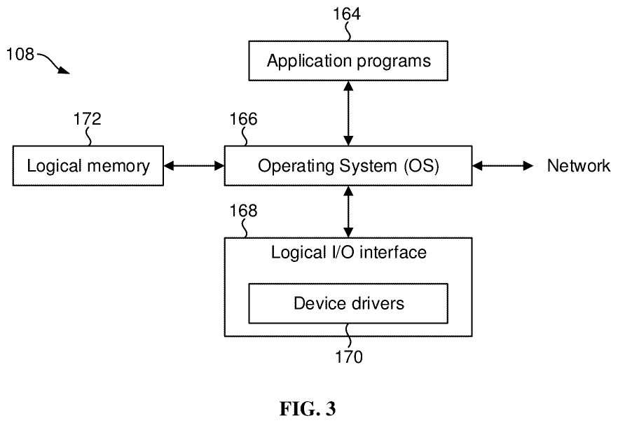

FIG. 3 shows a simplified software architecture 160 of the computing device 108. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 108 via the logical I/O interface 168, manages the logical memory 172, and manages and supports the application programs 164. The operating system 166 is also in communication with other computing devices (not shown) via the network to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

Herein, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

A module may be a part of a device, an apparatus, a system, and/or the like, wherein the module may be coupled to or integrated with other parts of the device, apparatus, or system such that the combination thereof forms the device, apparatus, or system. Alternatively, a module may be implemented as a standalone device or apparatus.

A module may execute a procedure for performing one or more specific tasks. Herein, a procedure has a general meaning equivalent to that of a method, and does not necessarily correspond to the concept of computing process (which is the instance of a computer program being executed). More specifically, a procedure herein is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module, or more specifically, one or more circuits such as one or more processors thereof may read the computer-executable code from the storage devices and execute the computer-executable code to perform the procedures.

Alternatively, a procedure may be implemented as one or more hardware structures having necessary electrical and/or optical components, circuits, logic gates, integrated circuit (IC) chips, and/or the like.

Those skilled in the art will appreciate that, in various embodiments, the computing device 108 may comprise some or all of the hardware components 122 to 138, some or all of the software components 164 to 172, and/or other hardware/software components as needed. For example, in some embodiments, the computing device 108 may not comprise any network interface 128. In some other embodiments, the computing device 108 may be an MCU having one or more processors and one or more computer-readable storage media for monitoring the distributed link features of the fiber optic channel 104 in real-time, wherein the method disclosed herein may be implemented as software programs and/or firmware programs stored in the one or more computer-readable storage media. In yet some other embodiments, the computing device 108 may be a digital signal processing (DSP) module comprising a circuitry for monitoring the distributed link features of the fiber optic channel 104 in real-time, and the method disclosed herein may be implemented as firmware programs stored in the one or more computer-readable storage media functionally connected to the DSP module, or may be implemented (or “hard-coded”) as part of the circuitry of the DSP module.

As described above, the computing device 108 is used for monitoring the fiber optic channel 104.

In some fiber optic systems, a type of Rx-side DSP-based optical performance monitoring (OPM) methods called power profile estimation (PPE) may be used for real-time monitoring distributed link features.

There are two main PPE methods, that is, the correlation method (CM) and the minimum-mean-square-error method (MMSE), both involving non-linear perturbation matrix computation.

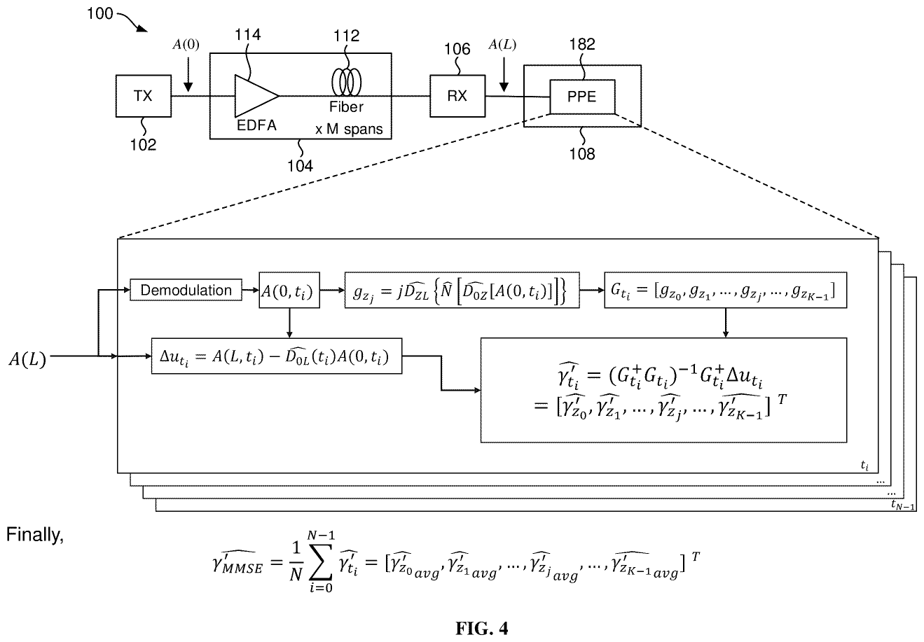

As shown in FIG. 4, the Tx 102 transmits an optical signal (that is, an electrical field envelope) A(z, t) propagating inside a single mode fiber (SMF) link 112 of the fiber optic channel 104 (and may be amplified by an amplifier 114 (such as an EDFA) if needed), where t and z are travel time and distance, respectively. The Rx 106 is coupled to a computing device 108, which comprises a PPE module 182 for calculating the PPE.

A(z, t) is governed by nonlinear Schrodinger equation (NLSE):

$$\frac{\partial A ( z , t )}{\partial z} - j ( \frac{{β}_{2} ( z )}{2} ) ( \frac{{\partial }^{2} A ( z , t )}{\partial {t}^{2}} ) = j {γ}^{′} ( z ) {\vert A ( z , t ) \vert}^{2} A ( z , t ) \qquad ( 1 )$$

$${γ}^{′} ( z ) = γ ( z ) P ( 0 ) exp ( - {\int }_{0}^{z} α ( {z}^{′} ) {dz}^{′} ) = γ ( z ) P ( z ) \qquad ( 2 )$$

where:
α(ω) is fiber loss/attenuation coefficient; α(z) is a constant (in dB/km);
β₂(ω) is the 2nd order group velocity dispersion coefficient; β₂(z) is a constant (in ps²/km).

γ(z) is nonlinear coefficient of fiber (in W⁻¹ km⁻¹ or 1/W·km);
P(0) is the launch power (in dBm); and
P(z) is the signal power at position z (in dBm).

From Equation (2), it can be seen that γ′(z) reflects the fiber longitudinal power evolution of A(z, t). Thus, if γ′(z) can be calculated or estimated, then the characteristics of signal traveling inside the fiber link may be obtained.

However, γ′(z) may not be mathematically calculatable since P(z) is unknown (γ(z), however, is known, and is constant). Therefore, one may estimate γ′(z) as follows.

Generally consider that there are K numbers of positional steps in the link 112, the estimated γ′ (denoted [symbol] ) may be expressed as

$$\text{?} = {[ \text{?} , … , \text{?} ]}^{T} .$$

There are two main techniques to calculate \hat{γ}′:

### Correlation Method (CM):

$$\text{?} = {G}^{+} Δ U ( L )$$

where G is the non-linear perturbation matrix with a dimension of N×K, where N is the number of samples over the collection period, and K is number of positional steps in the fiber link 112, (·)⁺ represents conjugate transpose of the matrix (⋅) (thus, G⁺ is the conjugate transpose of G, with a dimension of K×N), L is the total length of the link 112, and ΔU(L)=[Δuₜ_{₀}, Δuₜ_{₁}, Δuₜ_{₂}, . . . , Δuₜ_{_{N-1}}]^{T} represents the nonlinear interference (with a dimension of N×1).

### Minimum-Mean-Square-Error Method (MMSE):

$$\text{?} = {( {G}^{+} G )}^{- 1} {G}^{+} Δ U ( L )$$

where (⋅)⁻¹ represents the inverse of the matrix (⋅).

Thus, [symbol] or [symbol] may be calculated once G and Δu are obtained.

The calculation of Δu may be performed as follows.

Based on the regular perturbation (RP) method, the receiving signal, which can be collected by the DSP of the Rx 106, has the following relation:

$$A ( L , t ) \approx U ( L , t ) + Δ U ( L , t )$$

where U(L, t) is the received signal with linear distortions. Then,

$$U ( L , t ) = \text{?} A ( 0 , t ) \qquad ( 3 )$$

where A(0, t) is the original signal (that is, the signal transmitted at the Tx 102), and may be obtained at Rx 106 by decomposing A(L, t); and

$$\text{?} = {ℱ}^{- 1} {D}_{0 L} ( ω ) ℱ$$

where [symbol] ⁻¹ and [symbol] is inverse Fourier transformation and the Fourier transformation, respectively, and

$${D}_{{z}_{1} {z}_{2}} ( ω ) = exp ( - j \frac{{ω}^{2}}{2} {\int }_{{z}_{1}}^{{z}_{2}} {β}_{2} ( z ) dz )$$

is a linear operator. Thus, u(L, t) can be calculated by Equation (3).

A(L, t) is measured by the DSP at Rx 106. Thus,

$$Δ U ( L , t ) = A ( L , t ) - U ( L , t ) .$$

Then, the calculation of G may be performed as follows.

G is a N×K nonlinear perturbation matrix, where N is the number of samples taken in a sampling period, and K is the total number of discrete spatial steps of the fiber link 112 in length L, that is,

$$G = [ \begin{matrix}{g}_{{z}_{0}} ( {t}_{0} ) & {g}_{{z}_{0}} ( {t}_{0} ) & ⋯ & {g}_{{z}_{j}} ( {t}_{0} ) & ⋯ & {g}_{{z}_{K - 1}} ( {t}_{0} ) \\ {g}_{{z}_{0}} ( {t}_{1} ) & {g}_{{z}_{1}} ( {t}_{1} ) & ⋯ & {g}_{{z}_{j}} ( {t}_{1} ) & ⋯ & {g}_{{z}_{K - 1}} ( {t}_{1} ) \\ ⋮ & ⋮ & ⋱ & ⋮ & ⋱ & ⋮ \\ {g}_{{z}_{0}} ( {t}_{i} ) & {g}_{{z}_{1}} ( {t}_{i} ) & ⋯ & {g}_{{z}_{j}} ( {t}_{i} ) & ⋯ & {g}_{{z}_{K - 1}} ( {t}_{i} ) \\ ⋮ & ⋮ & ⋱ & ⋮ & ⋱ & ⋮ \\ {g}_{{z}_{0}} ( {t}_{N - 1} ) & {g}_{{z}_{1}} ( {t}_{N - 1} ) & ⋯ & {g}_{{z}_{j}} ( {t}_{N - 1} ) & ⋯ & {g}_{{z}_{K - 1}} ( {t}_{N - 1} )\end{matrix} ]$$

where the matrix element, g_{z}_{ⱼ}(tᵢ), is a short form for:

$${g}_{{z}_{j}} ( {t}_{i} ) = Δ {u}_{{z}_{j}} ( L , {t}_{i} ) ( {z}_{j} - {z}_{j - 1} ) with \begin{matrix}{t}_{0} \leq {t}_{i} \leq {t}_{N - 1} \\ {z}_{0} \leq {z}_{j} \leq {z}_{K - 1}\end{matrix}$$

$$Δ {u}_{z} ( L , t ) = j \text{?} \{ \hat{N} [ \text{?} [ A ( 0 , t ) ] ] \}$$

$$\text{?} = {ℱ}^{- 1} \text{?} ( ω ) ℱ$$

$$\text{?} ( ω ) = exp ( - j \frac{{ω}^{2}}{2} {\int }_{{z}_{1}}^{{z}_{2}} {β}_{2} ( z ) dz ) , and$$

$$\hat{N} [ \cdot ] = {\vert \cdot \vert}^{2} ( \cdot ) is a nonlinear operator .$$

Define the spatial step granularity Δz as:

$$Δ z = \frac{L}{K}$$

wherein, as described above, L is the total length of fiber link, and K is the total number of spatial steps.

Then, to ensure stable PPE estimation using the MMSE method, the following condition must be held true:

$$\frac{1}{\vert {β}_{2} \vert {BW}^{2} Δ z} < 12.84 \times 1 {0}^{- 6} .$$

That is,

$$Δ z > \frac{77900}{\vert {β}_{2} \vert {BW}^{2}} [ in km ]$$

where BW is equal to the signal symbol rate (in GHz), and β₂ is the dispersion coefficient (in ps²/km).

For example, for 16QAM 128 GBd signal (BW=128 GHZ) and β₂=−21.6 ps²/km, the lower limit of

$$Δz is \frac{77900}{\vert - 21.6 \vert {128}^{2}} = 0.22 km .$$

If Δz is smaller than this limit, then the column vectors of perturbation matrix G are no longer linearly independent, thereby causing the rank of G to become smaller than K. Consequently, the MMSE calculation would collapse.

However, since the non-uniform distribution of Δz has no impact on G column vectors' linear independency, uniform Δz is not required for PPE calculation.

Finally,

$$\text{?} = \frac{1}{N} {\sum }_{i = 0}^{N - 1} \text{?} = {[ \text{?} … , \text{?} … , \text{?} ]}^{T} .$$

In many scenarios, the above-described PPE method uses fine grind and uniform Δz. This approach, however, is not adequate to be used as a commercial solution because the computing power on the network elements (NEs; such as the computing device 108) cannot support the large computing demands required by the algorithm.

A smaller spatial step, Δz, leads to finer PPE results (provided Δz>Δzₗᵢₘᵢₜ). Thus, using fine grind and uniform Δz in the above-described PPE method is similar to a brute-force search for an anomaly location.

Although using small and uniform spatial granularity may be plausible in academic research and prototyping which use small lab dataset, it may not be feasible in commercial solutions, which must concern large networks and limited computing resources on NEs (or transponders) where PPE is computed. More specifically, two problems may be encountered.

The first problem is that the matrix computation in the above-described PPE method is CPU and/or RAM intensive if K is large. NE may fail to compute due to limited computing resource.

The second problem is related to the computing time. Even if the computing resource on NE permits the required matrix computation, the time it takes for computation may fail the requirement of real-time programming. Note that although the row operations of G can be computed in parallel, the column operations cannot, that is, the column operation must finish within the sampling period, which is challenging (if not impossible) with large K.

In the following various embodiments of a PPE method using optimized non-uniform spatial computation-step distribution are described, which provide a solution that takes less spatial steps (and thus consumes less computing power) than the uniform and small spatial granularity approach.

The PPE method disclosed herein leverage the software-defined networking (SDN) controller's global knowledge of the network to optimize PPE computation. Moreover, the PPE method disclosed herein defines and calculates a risk factor of a segment, and combines a risk-map application with PPE, which provides an efficient way to offer observability of the real-time health status of network services.

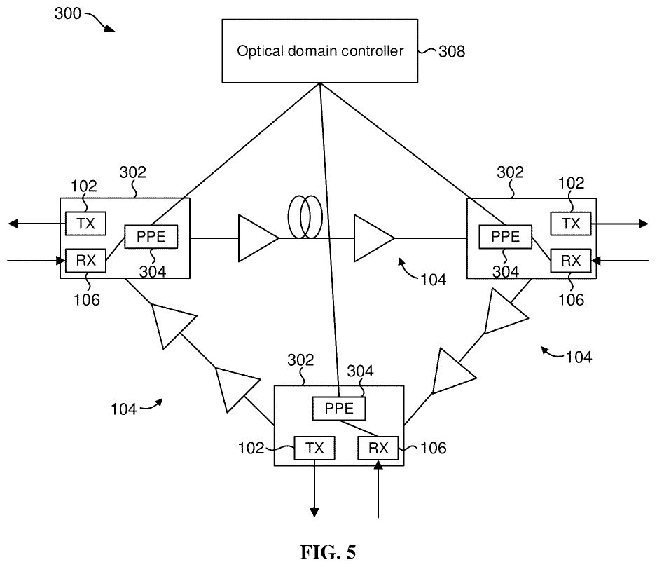

FIG. 5 is a schematic diagram showing a fiber optic system 300 for fiber-longitudinal PPE using optimized non-uniform spatial computation-step distribution, according to some embodiments of this disclosure. As shown, the system 300 comprises a fiber optic network having a plurality of wavelength division multiplexing (WDM) devices 302, such as a plurality of reconfigurable optical add-drop multiplexer (ROADM) devices, in communication with each other via a plurality of fiber optic channels 104. An optical domain controller 308 controls the WDM devices 302.

Each WDM device 302 comprises a Tx 102, a Rx 106, and a PPE component 304 connected to the Rx 106. The PPE component 304 performs the PPE calculation and reports anomaly to the optical domain controller 308. In some embodiments, the PPE component 304 may be the computing device 108. For example, in some embodiments, the PPE component 304 may be an embedded system located in the same device as the Rx DSP (such as a transponder).

As shown in FIG. 6, each optical channel (OCh) 104 may be partitioned into a plurality of optical multiplex sections (OMS) 312 with each OMS 312 between a neighboring pair of wavelength selective switches (WSS) 314. An OMS 312 may be further partitioned into a plurality of optical transmission sections (OTS) 316 with each OTS 316 comprising a fiber link 112 between a neighboring pair of amplifiers 114.

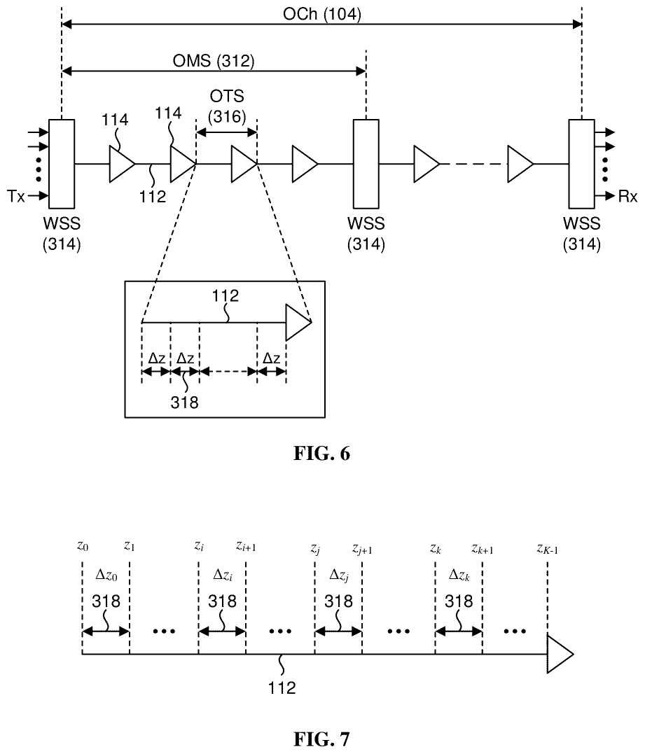

As shown in FIG. 7, the fiber link 112 of each OTS 316 may be partitioned into K segments 318 (K≥1) each corresponding to a spatial step Δz. In these embodiments, the segments 318 do not necessarily have an equal size. In other words, the sizes of the segments 318 may be in a uniform distribution or may be in a non-uniform distribution (denoted a “non-uniform spatial (K) distribution” hereinafter.)

The optical domain controller 308 maintains a global view of the anomaly distribution over the entire network, and calculates the spatial (K) distribution based on an anomaly probability density function. In some embodiments, the optical domain controller 308 is in bidirectional communication with the PPE component 304 of each WDM device 302, wherein the optical domain controller 308 assigns K distribution of segments to the PPE component 304 of each WDM device 302 (that is, partitioning the associated fiber link 112 into K segments following the K distribution), and the PPE component 304 of each WDM device 302 reports anomaly to the optical domain controller 308.

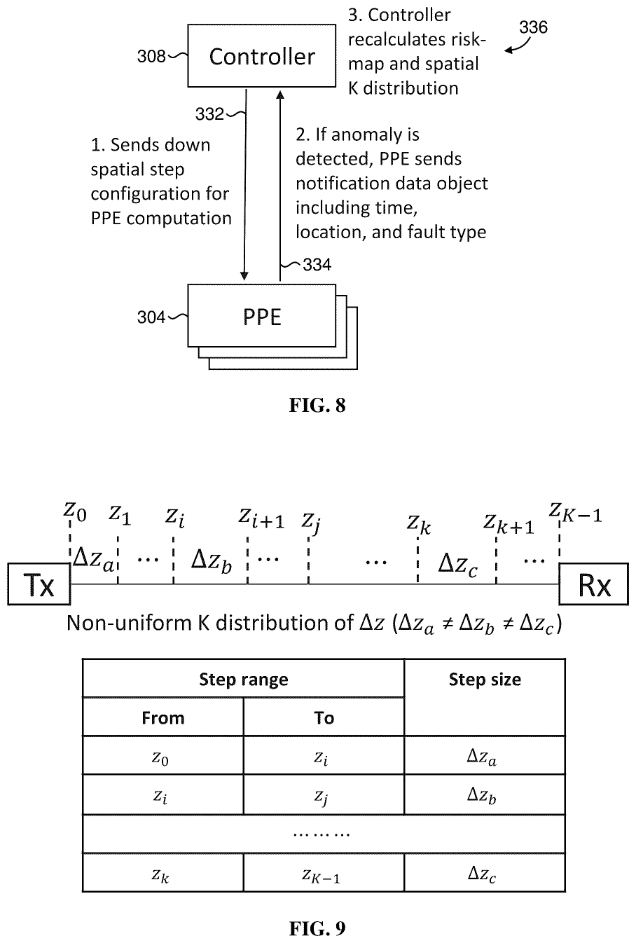

As shown in FIG. 8, the optical domain controller 308 sends to the PPE component 304 of each WDM device 302 the spatial step configuration (that is, the assigned K distribution of segments; also see FIG. 7) for PPE computation (step 332). An example of the spatial step configuration calculated by the optical domain controller 308 and sent to a PPE component 314 is shown in FIG. 9. In this example, the initially assigned K distribution of segments comprise K segments 318 corresponding to Δzₐ, Δz_{b}, . . . , Δz_{c}.

In various embodiments, the K distribution of segments is generally of a non-uniform distribution. In other words, the sizes (also called “step sizes”) Δzₐ, Δz_{b}, . . . , Δz_{c} of the K segments 318 are generally different, although some or all of the sizes Δzₐ, Δz_{b}, . . . , Δz_{c} may be the same. In some embodiments, the spatial step configuration may be compacted by grouping the same-size segments.

Referring back to FIG. 8, if anomaly is detected by a WDM device 302, the PPE component 304 thereof sends (step 334) to the optical domain controller 308 a notification data object which includes time, location, fault type, and/or the like. At step 336, the optical domain controller 308 recalculates the risk map and spatial (K) distribution.

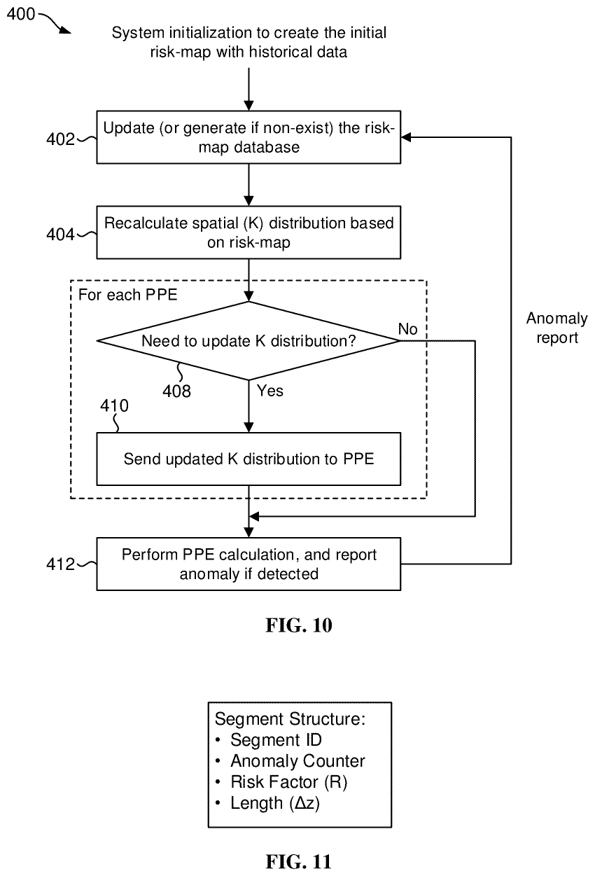

FIG. 10 is a flowchart showing a procedure 400 for monitoring optical performance using PPE, according to some embodiments of this disclosure. In these embodiments, steps 402 to 410 are performed by the optical domain controller 308, and step 412 is performed by the NE 108. In some other embodiments all steps 402 to 412 may be performed by one or more processors or circuits of the optical domain controller 308.

The procedure 400 starts after the system 300 initialization to create the initial risk map with historical data. At step 402, the optical domain controller 308 updates the risk-map database, or generate the risk-map database if it does not exist.

Accordingly, each unit in the risk-map database comprises the information of a respective segment with the data structure as shown in FIG. 11, including:
a segment identifier (ID);
an anomaly counter;
a risk factor (R); and
a length (Δz).

Referring back to FIG. 10, at step 404, the optical domain controller 308 recalculates the spatial (K) distribution based on the risk map.

Then, for each PPE component 304, a set of steps 408 to 410 are performed. More specifically, for each PPE component 304, the optical domain controller 308 checks if the PPE component 304 needs to update its spatial (K) distribution (step 408). If not, the procedure 400 goes to step 412.

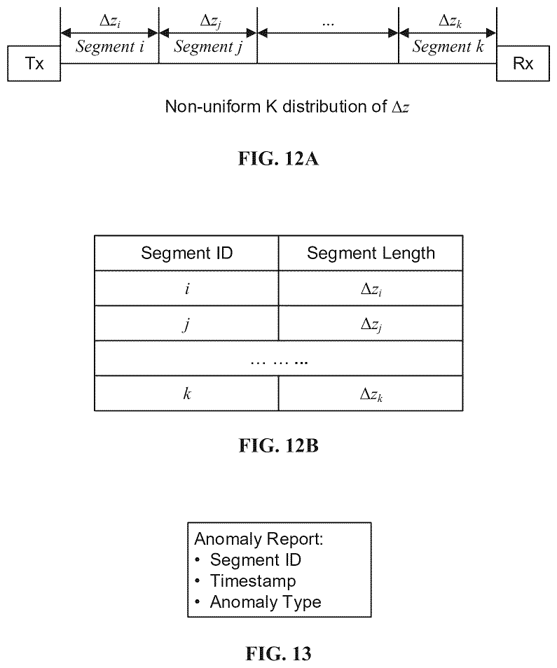

If at step 408, the optical domain controller 308 determines that the PPE component 304 needs to update its spatial (K) distribution, the optical domain controller 308 then sends the updated spatial (K) distribution to the PPE component 304 (step 410), using a suitable data structure, such as the data structure shown in FIG. 12B. As shown in FIG. 12B and also with reference to FIG. 12A, the data structure for sending the updated spatial (K) distribution comprises a plurality of records. Each record corresponds to a respective segment, and comprises a segment ID (such as i, j, . . . , k) and a corresponding segment length (such as Δzᵢ, Δzⱼ, . . . , Δzₖ).

Referring back to FIG. 10, at step 412, the PPE component 304 performs the PPE calculation, and reports any anomaly to the optical domain controller 308 (if needed) by sending an anomaly report thereto. The procedure 400 then goes to step 402.

FIG. 13 shows an example of the data structure of the anomaly report, which comprises one or more records each corresponding to an anomaly. Each record comprises a segment ID, a timestamp of the anomaly, and the anomaly type.

In some embodiments, the risk factor (R) of a segment may be calculated as follows.
(i) Calculate the average anomaly rate of entire network as:

$$\overline{θ} = \frac{total \# of anomaly reported of entire network}{total \# of segments of entire network} .$$

(ii) Calculate the average anomaly rate of target segment as:

$${\overline{θ}}_{s e g m e n t} = \overline{θ} ( \frac{{length}_{segment}}{{avg\_length}_{segment}} )$$

where:

$${avg\_length}_{s e g m e n t} = \frac{total fiber length of entire network}{total \# of segments of entire network} .$$

(iii) Calculate the expected probability (P) of x anomaly in the target segment (with Poison distribution of random faults) as:

$${P}_{s e g m e n t} ( X = x ) = \frac{( {e}^{- {\overline{θ}}_{segment}} ) {( {\overline{θ}}_{segment} )}^{x}}{x !} .$$

(iv) Calculate the observed frequency (f) of anomaly in the target segment as:

$${f}_{segment} ( x ) = \frac{\# of segment with [ x ( \frac{{length}_{segment}}{{avg}_{{length}_{segment}}} ) ] number of anomaly}{total \# of segments} .$$

(v) The risk factor (R) of the target segment may be calculated as:

$${R}_{s e g m e n t} = \frac{{f}_{s e g m e n t ( x )}}{{P}_{s e g m e n t} ( X = x )} .$$

If the risk factor R_{segment} of the segment is greater than a predefined threshold, such as R_{segment}>1, then the target segment is a hotspot, and may be evenly split into a plurality of segments (such as two segments).

In some embodiments, when the optical domain controller 308 receives from a PPE component 304 an anomaly report against a segment, the optical domain controller 308 updates the risk map (step 402 shown in FIG. 10), and recalculates the risk factor (R) of the segment at step 404 shown in FIG. 10 using the above-described method (steps (i) to (v)). As described above, if the risk factor of a segment R_{segment}>1, then this segment may be split into a plurality of segments (such as two segments) if the length of the segment has not reached its theoretical minimum (for example, if the current segment length is greater than or equal to two times of the theoretical minimum length).

If any segment is split into multiple segments at step 404, then the K distribution needs to be updated (the “Yes” branch of step 408); otherwise, the K distribution does not need to be updated (the “No” branch of step 408).

In some embodiments, θ̅_{segment} calculation may be extended to include conditional parameters to model factors, such as fiber age, geographical conditions, and/or the like.

In some embodiments, other suitable methods, such as chi-square goodness-of-fit test, may be used to calculate the risk factor in the last step (that is, step (v)) to filter out statistical noise.

In some embodiments, the following method may be used to update the spatial (K) distribution based on segment risk factor. In these embodiments, the method correlates the density of the spatial step K distribution with the risk factor of the segments. A higher the risk factor of a segment means that the spatial steps of that segment are denser.

In these embodiments, the risk factor of a segment is updated every time that an anomaly is detected (and reported) by a PPE component 304.

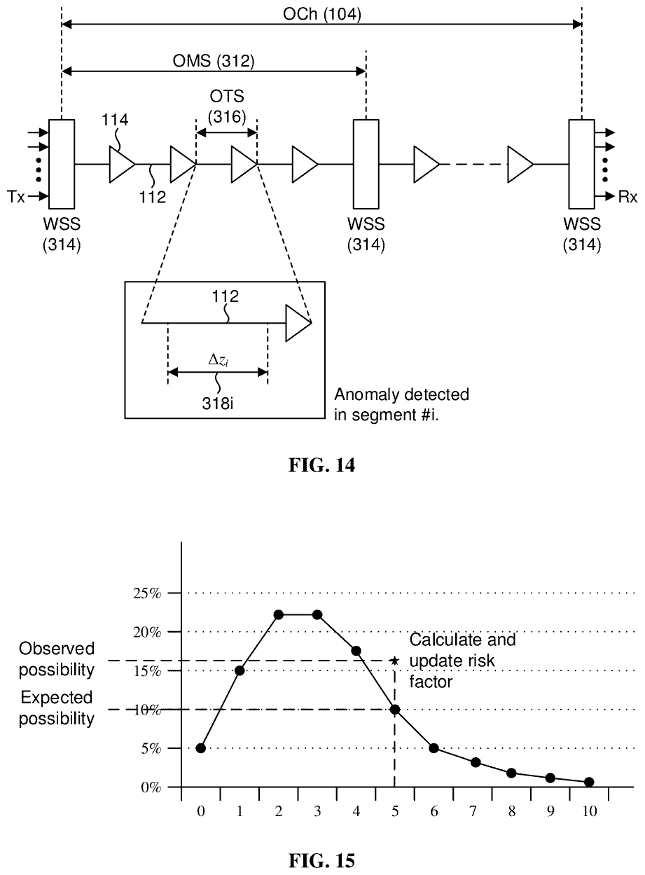

For example, as shown in FIG. 14, anomaly in a segment 318i (that is, the i-th segment, where i=5 in this example) is detected. Then, the risk factor of segment 318i is updated. As shown in FIG. 15, while the expected possibility of anomaly in segment 318i (i=5) is 10%, the updated possibility of anomaly is about 17%. Then, the updated risk factor is greater than one (1).

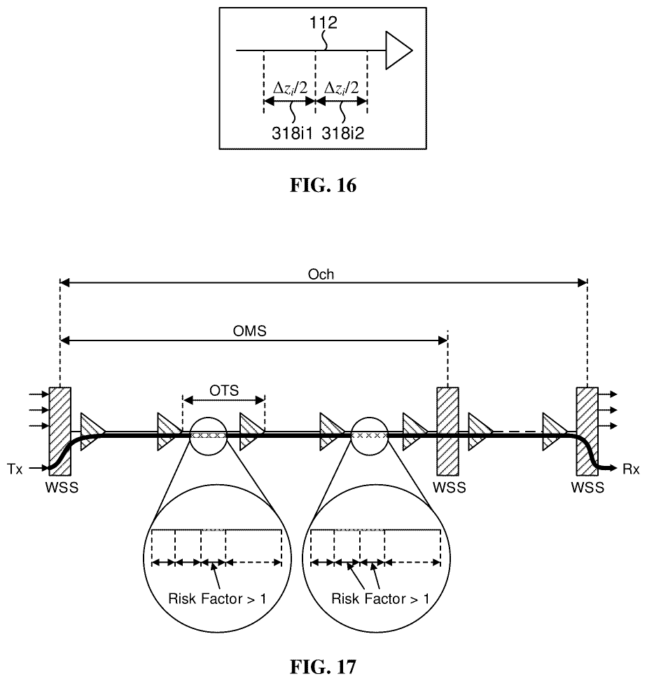

If the updated risk factor is greater than one (1), then the spatial density of the segment 318i in question is increased. For example, as shown in FIG. 16, the segment 318i is split to two segments 318i1 and 318i2, thereby doubling the spatial density of the previous segment 318i.

Thus, when doubling the spatial density of the segment with detected anomaly, this method is essentially the binary search for an anomaly location, and the splitting of the segment will stop when the segment length reaches its lower limit, that is, when the segment length reaches its theoretical minimum length. For example, if the current segment length is less than two times of the theoretical minimum length, then, the splitting of the segment will stop.

FIG. 17 shows an example of hotspot visualization, which provides a graphic user interface (GUI) for identifying and displaying the hotspots at the service level with improved observability of the risk map at the service level. Such a hotspot visualization may be provided by the optical domain controller 308 based on data from its risk-map database. Customer can use this feature to navigate the services and retrieve detailed information of hotspots. While the example shown in FIG. 17 is in back-and-white line drawing style, other suitable graphic features such as colored hotspots in link segments on the risk map may be presented. The user can zoom-in to see the details by clicking the colored hotspots, and the details of the clicked hotspots may be shown as, e.g., zoomed-in presentation in the circles.

Thus, the method disclosed herein provides an efficient computation of non-uniform spatial step distribution of PPE, which may solve the above-described problems that may otherwise limit PPE's applications, and facilitate the commercialization of PPE.

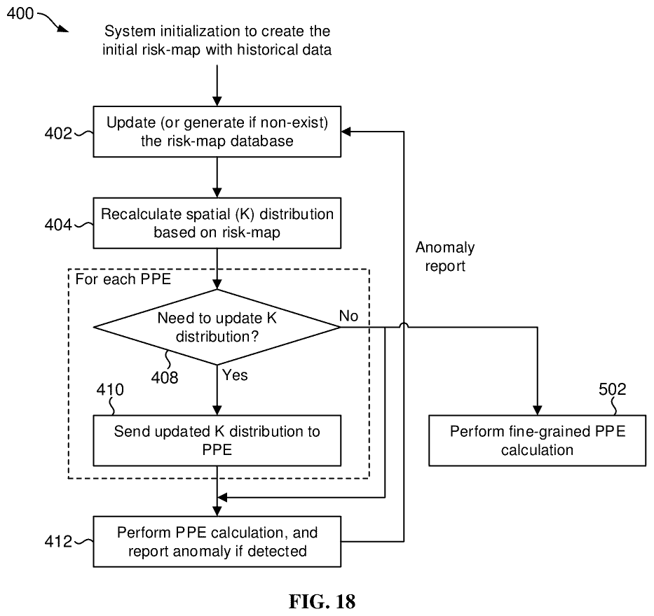

FIG. 18 is a flowchart showing a procedure 400 for monitoring optical performance using PPE, according to some embodiments of this disclosure. The procedure 400 in these embodiments is similar to that shown in FIG. 10, except that, at step 408, if the optical domain controller 308 determines that the PPE component 304 does not need to update its spatial (K) distribution, the optical domain controller 308 performs step 412 (performing PPE calculation, and reporting anomaly if detected), and also performs fine-grained PPE calculation (step 502).

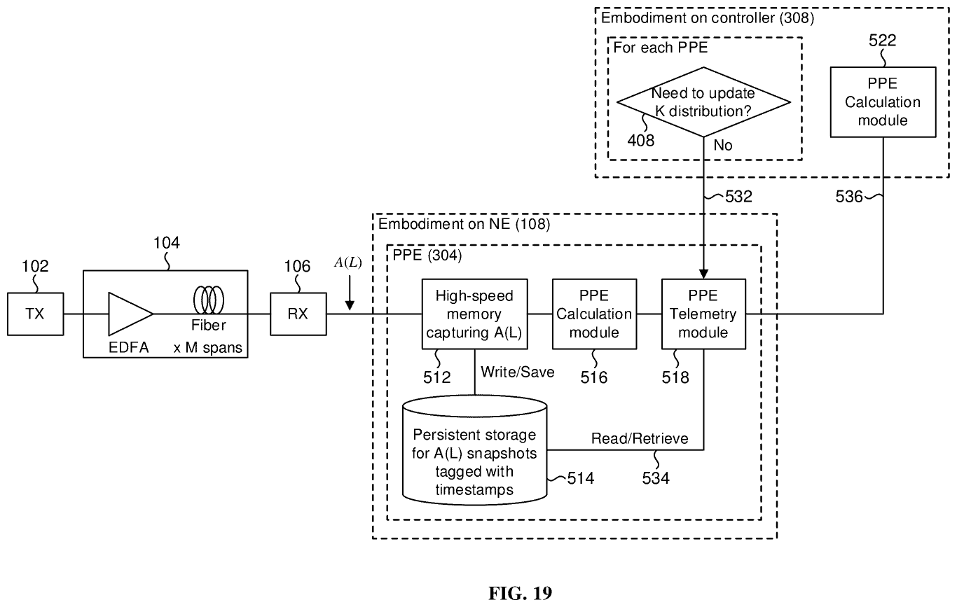

FIG. 19 shows the detail of step 502. As can be seen, step 502 involves several function blocks or modules (described in more detail later), according to some embodiments of this disclosure. In the example shown in FIG. 19, function modules 408 (see FIGS. 18) and 522 are implemented on the optical domain controller 308; and function modules 512, 514, 516, and 518 are implemented in the PPE component 304 of the NE 108.

As shown in FIG. 19, a high-speed memory 512 in the PPE component 304 of the NE 108 captures or otherwise receives the output A(L) of the Rx 106, and stores A(L) in a storage 514 as A(L) snapshots tagged with timestamps. The A(L) snapshots are also used by the PPE calculation module 516 for PPE calculation.

As described above, at step 408, the fact that the optical domain controller 308 determines that the PPE component 304 does not need to update its spatial (K) distribution implies that the network anomaly may not be caused by persistent network equipment faults in a particular location (in which case the K distribution would be updated). Rather, the anomaly is a transient error that may be caused by random events such as lightning or road vibration caused by heavy vehicles crossing roads under which fibers are laid. In this case, fine-grained PPE calculation is needed for finding the precise location of the faults, which is a piece of important information for further root cause analysis. Thus, at step 408, when K distribution needs not to be updated, the optical domain controller 308 notifies the NE 108 (step 532) to collect timestamped telemetry data (saved in storage 514), which is needed for fine-grained PPE calculation performed by the optical domain controller 308. The NE 108 receives the notification from the optical domain controller 308 via the PPE telemetry module 518 thereof. In response, the NE 108 or more specifically the PPE 304 thereof reads or retrieves timestamped A(L) snapshots from the storage 514 (step 534) and sends the retrieved timestamped A(L) snapshots (via the PPE telemetry module 518) to the optical domain controller 308 (step 536), in which a PPE calculation module 522 thereof (which has sufficient computing power) performs PPE calculation as need using, for example, uniform fine-grained (that is, smallest) K step distribution to obtain the fine-grained PPE calculation results.

As those skilled in the art understand, the anomalies or errors in a fiber optic system 100 may comprise persistent anomalies such as those caused by loose connectors (which generally require identifying the locations thereof and repair), and random anomalies such as those caused by lightning (which often do not need repair). The system and method disclosed herein may be suitable for locating persistent anomalies with improved accuracy and efficiency, and may also determine locations of random anomalies to assist further root cause analysis.

The table below lists some acronyms/abbreviations and their corresponding full names.

| Acronym/Abbreviation/ | |
|---|---|
| Initialism | Full Name |
| PPE | Power Profile Estimation |
| DSP | Digital Signal Processor |
| OSNR | Optical Signal to Noise Ratio |
| CD | Chromatic Dispersion |
| OPM | Optical Performance Monitoring |
| OTDR | Optical Time Domain Reflectometry |
| CM | Correlation Method |
| MMSE | Minimum Mean Square Error |
| NLSE | Nonlinear Schrodinger Equation |
| SMF | Single Mode Fiber |
| RP | Regular Perturbation |
| BW | Bandwidth |
| QAM | Quadrature Amplitude Modulation |
| NE | Network Element |
| CPU | Central Processing Unit |
| RAM | Random Access Memory |
| Tx | Transmission |
| Rx | Reception |
| OCh | Optical Channel Layer |
| OMS | Optical Multiplex Section |
| OTS | Optical Transmission Section |
| EDFA | Erbium-Doped Fiber Amplifier |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method for managing a fiber optic network having one or more fiber optic links, the method comprising:
detecting an anomaly in a segment of one or more segments of the one or more fiber optic links;
calculating a risk factor of each of the one or more segments upon the detection of the anomaly; and
maintaining a risk map of the fiber optic network based on the detection of the anomaly and the calculated risk factors, for managing the fiber optic network.

2. The method of claim 1 further comprising:
if the risk factor of one of the one or more segments is greater than a predefined threshold, splitting the segment into a plurality of new segments for being included into said one or more segments.

3. The method of claim 2, wherein said splitting the segment into the plurality of new segments comprises:
splitting the segment into two new segments for being included into said one or more segments.

4. The method of claim 1, wherein the risk map comprises a plurality of units each corresponding to a respective segment of the one or more segments of the fiber optic network, each unit comprising:
a segment identifier (ID) of the corresponding segment;
an anomaly counter of the corresponding segment;
the risk factor of the corresponding segment; and
a length of the corresponding segment.

5. The method of claim 1, wherein said calculating the risk factor of each of the one or more segments upon the detection of the anomaly comprises:
calculating an average anomaly rate of the fiber optic network as:
$$\overline{θ} = \frac{total \# of anomaly reported of entire network}{total \# of segments of entire network} ;$$
calculating an average anomaly rate of each segment as:
$${\overline{θ}}_{s e g m e n t} = \overline{θ} ( \frac{{length}_{segment}}{{avg\_length}_{segment}} ) ,$$
where:
$${avg\_length}_{s e g m e n t} = \frac{total fiber length of entire network}{total \# of segments of entire network} ;$$
calculating an expected probability (P) of x anomaly in each segment as:
$${P}_{s e g m e n t} ( X = x ) = \frac{( {e}^{- {\overline{θ}}_{segment}} ) {( {\overline{θ}}_{segment} )}^{x}}{x !} ;$$
calculating an observed frequency (f) of anomaly in each segment as:
$${f}_{segment} ( x ) = \frac{\# of segment with [ x ( \frac{{length}_{segment}}{{avg}_{{length}_{segment}}} ) ] number of anomaly}{total \# of segments} ;$$
and
calculating the risk factor (R) of each segment as:
$${R}_{s e g m e n t} = \frac{{f}_{s e g m e n t ( x )}}{{P}_{s e g m e n t} ( X = x )} .$$

6. The method of claim 1 further comprising:
presenting the risk map on a graphic user interface (GUI).

7. A system comprising:
one or more estimators controllable by the controller, each estimator for functionally connecting to a respective receiver of one or more receivers in the fiber optic network, each receiver being coupled to a respective fiber optic link of the one or more fiber optic links in the fiber optic network; and
a controller collaborating with the one or more estimators for performing the method of claim 1.

8. The system of claim 7, wherein the method further comprises:
if the risk factor of one of the one or more segments is greater than a predefined threshold, splitting the segment into a plurality of new segments for being included into said one or more segments.

9. The system of claim 7, wherein the risk map comprises a plurality of units each corresponding to a respective segment of the one or more segments of the fiber optic network, each unit comprising:
a segment identifier (ID) of the corresponding segment;
an anomaly counter of the corresponding segment;
the risk factor of the corresponding segment; and
a length of the corresponding segment.

10. The system of claim 7, wherein said calculating the risk factor of each of the one or more segments upon the detection of the anomaly comprises:
calculating an average anomaly rate of the fiber optic network as:
$$\overline{θ} = \frac{total \# of anomaly reported of entire network}{total \# of segments of entire network} ;$$
calculating an average anomaly rate of each segment as:
$${\overline{θ}}_{s e g m e n t} = \overline{θ} ( \frac{{length}_{segment}}{{avg\_length}_{segment}} ) ,$$
where:
$${avg\_length}_{s e g m e n t} = \frac{total fiber length of entire network}{total \# of segments of entire network} ;$$
calculating an expected probability (P) of x anomaly in each segment as:
$${P}_{segment} ( X = x ) = \frac{( {e}^{- {\overline{θ}}_{segment}} ) {( {\overline{θ}}_{segment} )}^{x}}{x !} ;$$
calculating an observed frequency (f) of anomaly in each segment as:
$${f}_{segment} ( x ) = \frac{\# of segment with [ x ( \frac{{length}_{segment}}{{avg}_{{length}_{segment}}} ) ] number of anomaly}{total \# of segments} ;$$
and
calculating the risk factor (R) of each segment as:
$${R}_{segment} = \frac{{f}_{segment} ( x )}{{P}_{segment} ( X = x )} .$$

11. One or more processors functionally coupled to one or more non-transitory computer-readable storage media; wherein the one or more non-transitory computer-readable storage media comprise computer-executable instructions; and
wherein the instructions, when executed, cause the one or more processors to perform the method of claim 1.

12. The one or more processors of claim 11, wherein the method further comprises:
if the risk factor of one of the one or more segments is greater than a predefined threshold, splitting the segment into a plurality of new segments for being included into said one or more segments.

13. The one or more processors of claim 12, wherein said splitting the segment into the plurality of new segments comprises:
splitting the segment into two new segments for being included into said one or more segments.

14. The one or more processors of claim 11, wherein the risk map comprises a plurality of units each corresponding to a respective segment of the one or more segments of the fiber optic network, each unit comprising:
a segment identifier (ID) of the corresponding segment;
an anomaly counter of the corresponding segment;
the risk factor of the corresponding segment; and
a length of the corresponding segment.

15. The one or more processors of claim 11, wherein said calculating the risk factor of each of the one or more segments upon the detection of the anomaly comprises:
calculating an average anomaly rate of the fiber optic network as:
$$\overline{θ} = \frac{total \# of anomaly reported of entire network}{total \# of segments of entire network} ;$$
calculating an average anomaly rate of each segment as:
$${\overline{θ}}_{segment} = \overline{θ} ( \frac{{length}_{segment}}{{avg\_length}_{segment}} ) ,$$
where:
$${avg\_length}_{segment} = \frac{total fiber length of entire network}{total \# of segments of entire network} ;$$
calculating an expected probability (P) of x anomaly in each segment as:
$${P}_{segment} ( X = x ) = \frac{( {e}^{- {\overline{θ}}_{segment}} ) {( {\overline{θ}}_{segment} )}^{x}}{x !} ;$$
calculating an observed frequency (f) of anomaly in each segment as:
$${f}_{segment} ( x ) = \frac{\# of segment with [ x ( \frac{{length}_{segment}}{{avg}_{{length}_{segment}}} ) ] number of anomaly}{total \# of segments} ;$$
and,
calculating the risk factor (R) of each segment as:
$${R}_{segment} = \frac{{f}_{segment} ( x )}{{P}_{segment} ( X = x )} .$$

16. One or more non-transitory computer-readable storage media comprising computer-executable instructions, wherein the instructions, when executed, cause one or more processors to perform the method of claim 1.

17. The one or more non-transitory computer-readable storage media of claim 16, wherein the method further comprises:
if the risk factor of one of the one or more segments is greater than a predefined threshold, splitting the segment into a plurality of new segments for being included into said one or more segments.

18. The one or more non-transitory computer-readable storage media of claim 17, wherein said splitting the segment into the plurality of new segments comprises:
splitting the segment into two new segments for being included into said one or more segments.

19. The one or more non-transitory computer-readable storage media of claim 16, wherein the risk map comprises a plurality of units each corresponding to a respective segment of the one or more segments of the fiber optic network, each unit comprising:
a segment identifier (ID) of the corresponding segment;
an anomaly counter of the corresponding segment;
the risk factor of the corresponding segment; and
a length of the corresponding segment.

20. The one or more non-transitory computer-readable storage media of claim 16, wherein said calculating the risk factor of each of the one or more segments upon the detection of the anomaly comprises:
calculating an average anomaly rate of the fiber optic network as:
$$\overline{θ} = \frac{total \# of anomaly reported of entire network}{total \# of segments of entire network} ;$$
calculating an average anomaly rate of each segment as:
$${\overline{θ}}_{segment} = \overline{θ} ( \frac{{length}_{segment}}{{avg\_length}_{segment}} ) ,$$
where:
$${avg\_length}_{segment} = \frac{total fiber length of entire network}{total \# of segments of entire network} ;$$
calculating an expected probability (P) of x anomaly in each segment as:
$${P}_{segment} ( X = x ) = \frac{( {e}^{- {\overline{θ}}_{segment}} ) {( {\overline{θ}}_{segment} )}^{x}}{x !} ;$$
calculating an observed frequency (f) of anomaly in each segment as:
$${f}_{segment} ( x ) = \frac{\# of segment with [ x ( \frac{{length}_{segment}}{{avg}_{{length}_{segment}}} ) ] number of anomaly}{total \# of segments} ;$$
and
calculating the risk factor (R) of each segment as:
$${R}_{segment} = \frac{{f}_{segment} ( x )}{{P}_{segment} ( X = x )} .$$
